(19) United States
(12) Patent Application Publication
(10) Pub. No.: US 2024/0256477 A1
(43) Pub. Date: Aug. 1, 2024

(54) METHOD AND APPARATUS FOR PROCESSING DMA, AND COMPUTER-READABLE STORAGE MEDIUM

(71) Applicant: SUZHOU METABRAIN INTELLIGENT TECHNOLOGY CO., LTD., Suzhou, Jiangsu (CN)

(72) Inventors: Shuqing LI, Suzhou, Jiangsu (CN); Jiang WANG, Suzhou, Jiangsu (CN); Huajin SUN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/564,515

(22) PCT Filed: Apr. 29, 2022
(86) PCT No.: PCT/CN2022/090272

§ 371 Date: Nov. 27, 2023

(30) Foreign Application Priority Data
Oct. 27, 2021 (CN) 202111251475.4

(51) Int. Cl. G06F 13/28

(52) U.S. Cl. CPC G06F 13/28; G06F 2213/0026

(57) ABSTRACT

The present disclosure relates to the technical field of computers, and provides a method and apparatus for processing DMA, and a computer-readable storage medium. The method includes: acquiring a DMA task used for processing DMA, and acquiring state information of the task; judging, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task; and judging whether to perform subsequent processing on the task.

### CROSS-REFERENCE TO RELATED APPLICATION

The present application is a National Stage Application of PCT International Application No.: PCT/CN2022/090272 filed on Apr. 29, 2022, which claims priority to Chinese Patent Application 202111251475.4, filed before the China National Intellectual Property Administration (CNIPA) on Oct. 27, 2021, the disclosure of which is incorporated herein by reference in its entirety.

### TECHNICAL FIELD

The present disclosure relates to the technical field of computers, and in particular, to a method and apparatus for processing Direct Memory Access (DMA), and a computer-readable storage medium.

### BACKGROUND

With the rise of big data and artificial intelligence, the operation capability of a traditional Central Processing Unit (CPU) cannot meet the requirements, therefore various types of operation acceleration devices are widely used in a computer system for unloading the processing executed by the CPU on a data plane and concentrating CPU resources on a control plane, thereby avoiding the CPU becoming a bottleneck of the system. In a system containing hardware acceleration, source data and processed data are generally stored in a host memory, which facilitates the access of a host CPU. An operation acceleration device reads the source data from the host memory by means of Peripheral Component Interconnect Express (PCIe) Direct Memory Access (DMA), stores the source data in a hardware cache, and performs an operation based on the source data. An operation result is also temporarily stored in the hardware cache, and then is written into the host memory by means of the PCIe DMA. Finally, the hardware notifies the CPU by means of interrupting or writing a response frame to the host memory, and the CPU directly reads the operation result from the host memory. A typical PCIe DMA process is divided into at least two stages, in the first stage, the acceleration device acquires a descriptor linked list from the host end by means of the PCIe DMA and stores the descriptor linked list in the hardware cache; and in the second stage, the acceleration device parses the descriptor linked list to obtain a data address, and then acquires data from the address by means of the PCIe DMA.

According to the operation mechanism of a traditional DMA controller, during the process of waiting for data return in the first stage, there is a problem of bandwidth waste caused by an idle DMA channel.

In view of the above technology, seeking an efficient method for implementing DMA is an urgent problem to be solved by those having ordinary skill in the art.

### SUMMARY

Embodiments of the present disclosure provide a method and apparatus for processing DMA, and a computer-readable storage medium.

The embodiments of the present disclosure provide a method for processing DMA, including:
receiving a task used for processing DMA, and acquiring state information of the task;
judging, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task;
when the state information meets the first preset condition, controlling the descriptor DMA queue to process the first stage contained in the task;
when the state information meets the second preset condition, controlling the data DMA queue to process the second stage contained in the task; and
after the processing of the first stage or the second stage is completed, updating the state information of the task; and returning to the operation of receiving the task used for processing DMA, and acquiring the state information of the task by taking, as a new task, the task of the stage corresponding to the state information that does not meet the first preset condition or the second preset condition.

The first preset condition is that a descriptor cache contains a next-page address entry, the priority of the task is the highest in the descriptor DMA queue, and a bandwidth quota and a flow control quota are not equal to 0; and
the second preset condition is that data DMA contains descriptor information, the priority of the task is the highest in the data DMA queue, and the bandwidth quota and the flow control quota are not equal to 0.

In some exemplary implementations, the operation of acquiring the state information of the task includes:
setting a serial number corresponding to the task;
respectively writing the serial number into the data DMA queue and the descriptor DMA queue; and
acquiring the state information according to the serial number.

In some exemplary implementations, the state information contains Quality of Service (QoS) information, a state flag, data information, and the descriptor information; and
the QoS information includes the priority of the task and the bandwidth quota, the state flag includes the data DMA and descriptor DMA, the data information includes a current-page address, a current-page offset, the flow control quota and a total remaining size, and the descriptor information includes the current-page address, the current-page offset, a descriptor cache and the number of remaining entries.

In some exemplary implementations, the operation of controlling the descriptor DMA queue to process the first stage contained in the task includes:
judging whether the bandwidth quota and the flow control quota are equal to 0;
when the bandwidth quota and the flow control quota are equal to 0, executing the operation of judging, according to the stages contained in the task, whether the state information meets the first preset condition of the descriptor DMA queue and/or the second preset condition of the data DMA queue by taking the task of the first stage as a new task;
when either or both of the bandwidth quota and the flow control quota are not equal to 0, calculating a DMA parameter, wherein the DMA parameter includes a DMA transmission size, a current-page residual and a start address;
sending a DMA read request to a PCIe, and judging whether the total remaining size is equal to 0;
when the total remaining size is equal to 0, setting the descriptor DMA to be in a completed state; and
when the total remaining size is not equal to 0, returning to the operation of judging whether the bandwidth quota and the flow control quota are equal to 0;
the operation of controlling the data DMA queue to process the second stage contained in the task includes:
judging whether the bandwidth quota and the flow control quota are equal to 0;
when the bandwidth quota and the flow control quota are equal to 0, executing the operation of judging, according to the stages contained in the task, whether the state information meets the first preset condition of the descriptor DMA queue and/or the second preset condition of the data DMA queue by taking the task of the second stage as a new task;
when either or both of the bandwidth quota and the flow control quota are not equal to 0, calculating a DMA parameter, wherein the DMA parameter includes a DMA transmission size, a current-page residual and a start address;
sending a DMA read request to the PCIe, and judging whether the total remaining size is equal to 0;
when the total remaining size is equal to 0, setting the data DMA to be in a completed state; and
when the total remaining size is not equal to 0, returning to the operation of judging whether the bandwidth quota and the flow control quota are equal to 0.

In some exemplary implementations, after the operation of setting the descriptor DMA to be in the completed state, the method further comprises: judging whether the state flag of the data DMA indicates the completed state; and when the state flag of the data DMA indicates the completed state, sending a response signal to a calling party;
or,
after the operation of setting the data DMA to be in the completed state, the method further comprises: judging whether the state flag of the descriptor DMA indicates the completed state; and when the state flag of the descriptor DMA indicates the completed state, sending a response signal to a calling party.

In some exemplary implementations, after the operation of sending the response signal to the calling party, the method further includes:
recycling the serial number of the task of which the state flag of the data DMA indicates the completed state and the state flag of the descriptor DMA indicates the completed state.

The embodiments of the present disclosure further provide an apparatus for processing DMA, including:
an acquisition module, configured to acquire a DMA task used for processing DMA, and acquire state information of the task;
a judging module configured to judge, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task, when the state information meets the first preset condition, trigger a first processing module, when the state information meets the second preset condition, trigger a second processing module, and when the state information does not meet the first preset condition or the second preset condition, trigger an execution module;
the first processing module, configured to control the descriptor DMA queue to process the first stage contained in the task;
the second processing module, configured to control the data DMA queue to process the second stage contained in the task; and
the execution module, configured to return to trigger the acquisition module taking, as a new task, the task of the stage corresponding to the state information that does not meet the first preset condition or the second preset condition.

The first preset condition is that a descriptor cache contains a next-page address entry, the priority of the task is the highest in the descriptor DMA queue, and a bandwidth quota and a flow control quota are not equal to 0; and
the second preset condition is that data DMA contains descriptor information, the priority of the task is the highest in the data DMA queue, and the bandwidth quota and the flow control quota are not equal to 0.

The embodiments of the present disclosure further provide an apparatus for processing DMA, including a memory, used for storing a computer program; and
a processor, used for implementing the operations of the above method for processing DMA when executing the computer program.

The embodiments of the present disclosure further provide a computer-readable storage medium, wherein a computer program is stored on the computer-readable storage medium, and when executed by a processor, the computer program causes the processor to implement the operations of the above method for processing DMA.

According to the method for processing DMA provided in the present disclosure, the DMA task used for processing DMA is acquired, the state information of the task is acquired, and it is judged according to the stages contained in the task whether the state information meets the first preset condition of the descriptor DMA queue and/or the second preset condition of the data DMA queue, wherein the descriptor DMA queue is used for processing the first stage contained in the task, the data DMA queue is used for processing the second stage contained in the task, and it is judged whether to perform subsequent processing on the task. Therefore, in the method, the two stages of processing DMA are performed at the same time, when one of the two stages does not meet the condition, the next task is processed while the other stage of the previous task continues to be executed. By using the method, the problem of bandwidth waste caused by an idle DMA channel during the process of waiting for data return in the first stage is effectively avoided.

On this basis, the embodiments of the present disclosure further provide an apparatus for processing DMA and a computer-readable storage medium, which have the same beneficial effects.

### BRIEF DESCRIPTION OF THE DRAWINGS

To illustrate embodiments of the present disclosure more clearly, a brief introduction on the drawings which need to be used in the embodiments is given below. Apparently, the drawings in the description below are merely some embodiments of the present disclosure, based on which other drawings may also be obtained by those having ordinary skill in the art without any creative effort.

FIG. 1 is a flowchart of a method for processing DMA provided in the embodiments of the present disclosure;

FIG. 2 is a structural diagram of a DMA controller provided in the embodiments of the present disclosure;

FIG. 3 is a flowchart of another method for processing DMA provided in the embodiments of the present disclosure;

FIG. 4 is a structural diagram of an apparatus for processing DMA provided in the embodiments of the present disclosure; and

FIG. 5 is a structural diagram of an apparatus for processing DMA provided in the embodiments of the present disclosure.

### DETAILED DESCRIPTION

A clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those having ordinary skill in the art based on the embodiments in the present disclosure without any creative effort, fall into the protection scope of the present disclosure.

The embodiments of the present disclosure provide a method and apparatus for processing DMA, and a computer-readable storage medium.

In order to enable those having ordinary skill in the art to better understand the solutions of the present disclosure, the present disclosure will be further described in detail below in combination with the drawings and specific embodiments.

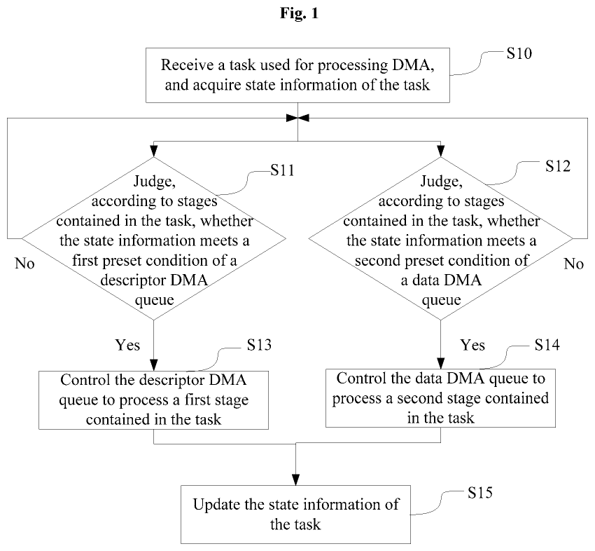

FIG. 1 is a flowchart of a method for processing DMA provided in the embodiments of the present disclosure. As shown in FIG. 1, the method for processing DMA includes operations S10 to S15.

At S10, a task used for processing DMA is received, and state information of the task is acquired.

At S11, whether the state information meets a first preset condition of a descriptor DMA queue is judged according to stages contained in the task. When the state information meets the first preset condition of the descriptor DMA queue, the flow enters operation S13. When the state information does not meet the first preset condition of the descriptor DMA queue, the flow returns to operation S11.

At S12, whether the state information meets a second preset condition of a data DMA queue is judged according to the stages contained in the task. When the state information meets the second preset condition of the data DMA queue, the flow enters operation S14. When the state information does not meet the second preset condition of the data DMA queue, the flow returns to operation S12.

At S13, the descriptor DMA queue is controlled to process a first stage contained in the task.

At S14, the descriptor DMA queue is controlled to process a second stage contained in the task.

At S15, the state information of the task is updated.

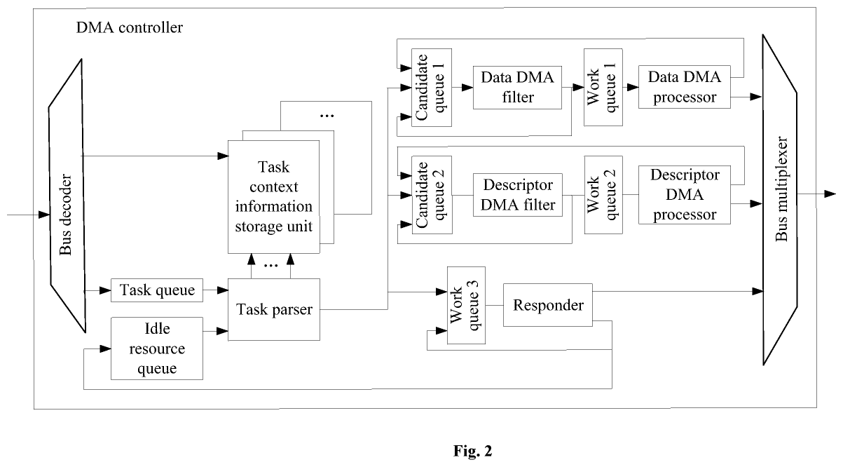

It may be understood that, as a technology for directly accessing a memory without relying on a CPU, DMA may enable the CPU to be released from a simple but heavy processing of data copying, so as to enable the CPU to execute more complex operations. An operation acceleration device is usually inserted into a computer in the form of a board card, and is connected with the CPU via a PCIe bus, so that a higher data bandwidth and greater flexibility may be obtained. However, a typical PCIe DMA process is usually divided into two stages, and the operation of the second stage is usually performed based on the information of the first stage, such that the two stages cannot be executed in parallel. Therefore, how to use the time that the second stage waits for the result of the first stage is a key point to be addressed by the embodiments of the present disclosure. In the operation S10, the task used for processing DMA is received, and the state information of the task is acquired according to the task. It should be noted that, the state information may refer to QoS information, data information and descriptor information of the task, as well as the priority of the task. In the embodiments, the specific content of the state information is not limited. FIG. 2 is a structural diagram of a DMA controller provided in the embodiments of the present disclosure. As shown in FIG. 2, after being received, the task is stored in a task queue, a task parser acquires the state information of the task based on the task in the task queue, and stores the state information in a task context information storage unit, wherein the task context information storage unit is used for storing the task and the state information contained in the task. There is a plurality of task context information storage units, each task corresponding to one task context storage unit, and the plurality of task context storage units may be processed at the same time. A candidate queue 1, a data DMA filter, a work queue 1 and a data DMA processor are referred to as the data DMA queue in the embodiments of the present disclosure, while a candidate queue 2, a descriptor DMA filter, a work queue 2 and a descriptor DMA processor are referred to as the descriptor DMA queue in the embodiments of the present disclosure. Data DMA and descriptor DMA are processed by means of the queues.

In addition, the stage mentioned in operation S11 and operation S12 refers to a processing progress of the task. A typical PCIe DMA process is divided into two stages. First, which stage the task is in is judged, when the task is currently in the first stage, it is judged whether the state information meets the first preset condition of the descriptor DMA queue, and it is judged whether the state information meets the second preset condition of the data DMA queue; when the task is currently in the second stage, it is directly judged whether the state information meets the second preset condition of the data DMA queue, and at this time, another task is currently performed in the first stage. In addition, as described in operation S11 and operation S12, when the state information meets the first preset condition, the flow proceeds to operation S13, and when the state information does not meet the first preset condition, the flow returns to operation S11. When the state information meets the second preset condition, the flow proceeds to operation S14, and when the state information does not meet the second preset condition, the flow returns to operation S12. It should be noted that, the purpose of returning to operation S11 and operation S12 is to wait for the completion of the processing in the other stage, after the state information of the task is updated, the state information may meet the first preset condition or the second preset condition, so as to continue the processing, rather than abandoning the task or leaving this stage idle and continuing to process the next task. After the state information of the task is updated, when the updated state information meets the condition, the processing may be continued. It may be understood that, with regard to the two stages of the PCIe DMA process provided in the embodiments of the present disclosure, two different tasks may be processed in the two stages. For example, the first stage of a task A is processed, since the information of the first stage needs to be used when performing the second stage, the second stage of the task A cannot be processed at the same time, therefore the second stage of a task B is processed in the second stage at this time.

In addition, in operation S13 and operation S14, the descriptor DMA queue is controlled to process the first stage contained in the task, and the data DMA queue is controlled to process the second stage contained in the task. It should be noted that, the descriptor DMA queue and the data DMA queue may process different stages of two tasks, and may also process the two stages of one task. In addition, after the first stage or the second stage contained in the task is processed, the state information of the task is updated. The content of state update is not limited. As an exemplary implementation, after the first stage is completed, the information that needs to be used in the second stage is updated, so that the second stage may be normally performed. As another exemplary implementation, the degree of completion may also be updated after the processing of the first stage or the second stage is completed.

Thus it may be seen that, according to the method for processing DMA provided in the embodiments of the present disclosure, the DMA task used for processing DMA is acquired, the state information of the task is acquired, and it is judged according to the stages contained in the task whether the state information meets the first preset condition of the descriptor DMA queue and/or the second preset condition of the data DMA queue, wherein the descriptor DMA queue is used for processing the first stage contained in the task, the data DMA queue is used for processing the second stage contained in the task, and it is judged whether to perform subsequent processing on the task. Therefore, in the method, the two stages of processing DMA are performed at the same time, when one of the two stages does not meet the condition, the next task is processed while the other stage of the previous task continues to be executed. By using the method, the problem of bandwidth waste caused by an idle DMA channel during the process of waiting for data return in the first stage is effectively avoided.

On the basis of the above embodiments, how to acquire the state information of the task is described as follows. The operation of acquiring the state information of the task includes three steps as follows:
a serial number corresponding to the task is set;
the serial number is respectively written into the data DMA queue and the descriptor DMA queue; and
the state information of the task is acquired according to the serial number.

It may be understood that, by means of numbering the task, and respectively writing the serial number into the data DMA queue and the descriptor DMA queue, the state information of the task may be queried according to the serial number. It should be noted that, the specific form of the serial number is not limited, for example, the serial number may be formed by English letters, or by Arabic numerals, or a combination of English letters and Arabic numerals. As shown in FIG. 2, the task and the state information of the task are stored in the task context information storage unit. In practical implementations, congestion may be caused in a queue when a task or task information is sent to the queue, and the implementation is complicated. In order to address this problem, an idle resource queue is used to record the serial number of a currently idle task context information storage unit. When the DMA controller resets, the idle resource queue will be initialized as a full state, recording all serial numbers N1 to Nn in sequence that correspond to all tasks, so the state information of the task may be queried according to the serial number. It may be understood that, the serial number of the task is equivalent to an ID number of a person, through which the information of the person may be queried.

In an exemplary embodiment, the serial number is respectively written into the data DMA queue and the descriptor DMA queue, whether the current task meets the first preset condition and the second preset condition is judged according to the state information which is queried according to the serial number. It should be noted that, one task context information storage unit corresponds to one DMA task, and the number of task context information storage units determines the maximum number of concurrent tasks for processing DMA. It should be noted that, querying the state information of the task according to the serial number provided in the present embodiment is merely an exemplary embodiment, and the specific manner may be selected according to actual situations.

Thus it may be seen that, according to the method for processing DMA provided in the embodiments of the present disclosure, the serial number of the task is set, the serial number of the task is sent to the data DMA queue and the descriptor DMA queue, the state information of the corresponding task is queried according to the serial number, the state information is stored in the task context information storage unit, one task context information storage unit corresponds to one DMA task, and the number of the task context information storage units determines the maximum number of concurrent tasks for processing DMA. In the method, the state information of the task is queried according to the serial number, so that the space in the queue may be saved; and the state information of the task is stored in the context information storage unit, so that an intermediate state of the task may be reserved, and the suspension and recovery of the task are supported.

On the basis of the above embodiments, the specific content of the state information is described as follows. It should be noted that, the present embodiment is merely used as an exemplary embodiment, and the specific content of the state information may be selected according to specific situations. The state information of the task contains related logic of arbitrary combinations of four registers, that is, Quality of Service (QOS), a state flag, data information and descriptor information. The QoS information includes priority information and a bandwidth quota of the task, where the bandwidth quota may be used for dynamically recording a remaining quota of the current task. The descriptor information further contains a current-page address, a current-page offset, the number of remaining entries and a descriptor cache. The descriptor DMA queue may complete one task within multiple times according to the size of the descriptor cache and various quota remaining values, and every time when the task is executed, a DMA operation is executed according to parameters such as the current-page address and the current-page offset, and when DMA data is returned, internal logic writes the data into the descriptor cache and updates the current-page address, the current-page offset and the number of remaining entries.

In addition, similar to the descriptor information, the data information also includes the current-page address, the current-page offset, a total remaining size and a flow control quota. The data DMA queue records an intermediate state of the current task according to information such as the current-page address, the current-page offset and the total remaining size. The flow control quota is used for recording the remaining space size of the current data destination end. In addition, the state flag includes data DMA and descriptor DMA, and when the descriptor DMA and the data DMA are completed, the corresponding state flag may be updated, so as to better reflect the progress of the task.

Thus it may be seen that, the state information mentioned in the embodiments of the present disclosure includes the QoS information, the state flag, the data information and the descriptor information. The four pieces of information all correspondingly have their own sub-information. The state information of the task may be updated by completing of the stages of the task. Alternatively, the storage unit may store all intermediate states during the execution of the task by means of setting the state information, so that the descriptor DMA and the data DMA operation may be executed in multiple times, and the switching between tasks may be supported. By using the method, the efficiency of a device for operating the data DMA and descriptor DMA may be effectively improved, and the problem of wasting channels may be avoided.

On the basis of the above embodiments, the specific content of the first preset condition and the second preset condition of the data DMA queue and the descriptor DMA queue is described as follows. In addition, the preset condition is used for performing a filtering operation on the tasks, so that the information which does not meet the condition is stored temporarily and is processed after the information is updated and the condition is met.

The first preset condition is that the descriptor cache contains a next-page address entry, the priority of the task is the highest in the descriptor DMA queue, and the bandwidth quota and the flow control quota are not equal to 0. The second preset condition is similar to the first preset condition. The second preset condition is that the data DMA contains descriptor information, the priority of the task is the highest in the data DMA queue, and the bandwidth quota and the flow control quota are not equal to 0. When the first preset condition or the second preset condition is met, data DMA processing or descriptor DMA processing is performed by the data DMA queue or the descriptor DMA queue. When the first or second condition is not met, the task is processed again as a new task to wait for the update of the state information, and the next task is processed before the state information is updated. It should be noted that, the first preset condition and the second preset condition provided in the present embodiment are only exemplary, and the first preset condition and the second preset condition may be defined according to specific situations.

Thus it may be seen that, in the method, the task is divided into two stages, and it is judged according to the first preset condition and the second preset condition whether the first stage and the second stage of the current task can be executed, thereby effectively avoiding the situation in which the task cannot be processed but has been started to be processed, such that the device does useless work, therefore the efficiency for processing DMA may be effectively improved.

In an exemplary embodiment, the processing of the first stage of the DMA task, that is, the operation of controlling the descriptor DMA queue to process the first stage contained in the task includes:
whether the bandwidth quota and the flow control quota are equal to 0 is judged;
when the bandwidth quota and the flow control quota are equal to 0, the operation of judging, according to the stages contained in the task, whether the state information meets the first preset condition of the descriptor DMA queue and/or the second preset condition of the data DMA queue is executed by taking the task of the first stage as a new task;
when either or both of the bandwidth quota and the flow control quota are not equal to 0, a DMA parameter is calculated, wherein the DMA parameter includes a DMA transmission size, a current-page residual and a start address;
a DMA read request is sent to a PCIe, and whether the total remaining size is equal to 0 is judged;
when the total remaining size is equal to 0, the descriptor DMA is set to be in a completed state; and
when the total remaining size is not equal to 0, the flow returns to the operation of judging whether the bandwidth quota and the flow control quota are equal to 0.

The processing of the second stage of the DMA task, that is, the operation of controlling the data DMA queue to process the second stage contained in the task includes:
whether the bandwidth quota and the flow control quota are equal to 0 is judged;
when the bandwidth quota and the flow control quota are equal to 0, the operation of judging, according to the stages contained in the task, whether the state information meets the first preset condition of the descriptor DMA queue and/or the second preset condition of the data DMA queue is executed by taking the task of the second stage as a new task;
when either or both of the bandwidth quota and the flow control quota are not equal to 0, a DMA parameter is calculated, wherein the DMA parameter includes a DMA transmission size, a current-page residual and a start address;
a DMA read request is sent to the PCIe, and whether the total remaining size is equal to 0 is judged;
when the total remaining size is equal to 0, the data DMA is set to be in a completed state; and
when the total remaining size is not equal to 0, the flow returns to the operation of judging whether the bandwidth quota and the flow control quota are equal to 0.

It should be noted that, the specific processing of the first stage and the second stage in the present embodiment is merely exemplary, and the processing of the first stage and the second stage may be defined according to specific situations. With regard to the processing of the first stage, as shown in FIG. 2, the candidate queue 2, the descriptor DMA filter, the work queue 2 and the descriptor DMA processor are referred to as the descriptor DMA sequence, when the task meets the first preset condition, the descriptor DMA filter writes, into the work queue 2, the serial number of the task context information storage unit corresponding to the task; when the work queue 2 is not empty, the descriptor DMA processor reads the serial number of the task context information storage unit, acquires the state information of the task according to the serial number, judges whether the bandwidth quota and the flow control quota of the current task are equal to 0, when the bandwidth quota and the flow control quota are equal to 0, returns to the candidate queue 2, and otherwise, calculates related parameters of the DMA, and accesses the PCIe via a bus to execute a DMA process, wherein the related parameters of the DMA include the current-page offset, the current-page address, the current-page residual and the start address. After the DMA process is received by the PCIe, the processor updates the state information of the task. If the DMA process is not received, the processor judges according to the bandwidth quota and the flow control quota whether to execute a next operation, and judges whether the current task has achieved complete ending or staged ending. If the current task has achieved complete ending, the quota is zero, and when the number of remaining entries is zero, the processor sets the state flag of the descriptor DMA to be in a completed state. If the current task has achieved staged ending, the processor writes back the serial number of the task into the candidate queue 2, and waits for the next execution.

The processing of the second stage is similar to that of the first stage. The candidate queue 1, the data DMA filter, the work queue 1 and the data DMA processor are referred to as the data DMA queue. When the task meets the second preset condition, the data DMA filter writes, into the work queue 1, the serial number of the task context information storage unit corresponding to the task; when the work queue 1 is not empty, the data DMA processor reads the serial number of the task context information storage unit, acquires the state information of the task according to the serial number, judges whether the bandwidth quota and the flow control quota of the current task are equal to 0, when the bandwidth quota and the flow control quota are equal to 0, returns to the candidate queue 1, and otherwise, calculates related parameters of the DMA, wherein the related parameters of the DMA include the current-page offset, the current-page address, the current-page residual and the start address. The PCIe is accessed via a bus to execute a DMA process, after the DMA process is received by the PCIe, the processor updates the state information of the task. If the DMA process is not received, the processor judges according to the bandwidth quota and the flow control quota whether to execute a next operation, and judges whether the current task has achieved complete ending or staged ending. If the current task has achieved complete ending, the quota is zero, and when the number of remaining entries is zero, the processor sets the state flag of the data DMA to be in a completed state. If the current task has achieved staged ending, the processor writes back the serial number of the task into the candidate queue 1, and waits for the next execution.

Thus it may be seen that, during the specific process of processing the first stage and the second stage provided in the embodiments of the present disclosure, by means of judging whether the bandwidth quota and the flow control quota are equal to 0, a conclusion of whether to continue the next operation is obtained, if not, the related parameters of the DMA are calculated, the PCIe is accessed via the bus to execute a DMA process, after the DMA process is received, the state information of the task is updated. It is also possible to judge whether the task in the current stage has achieved complete ending or staged ending, if the task has achieved staged ending, the task is returned to the candidate queue to wait for the next execution, and if the task has achieved complete ending, the state flag of the data DMA or the descriptor DMA is set to be in the completed state. Therefore, the efficiency of processing DMA may be effectively improved, the task may be divided into a plurality of operations, the task may be suspended, and the situation of channel waste when waiting for the return of information of the first stage in the second stage may be avoided.

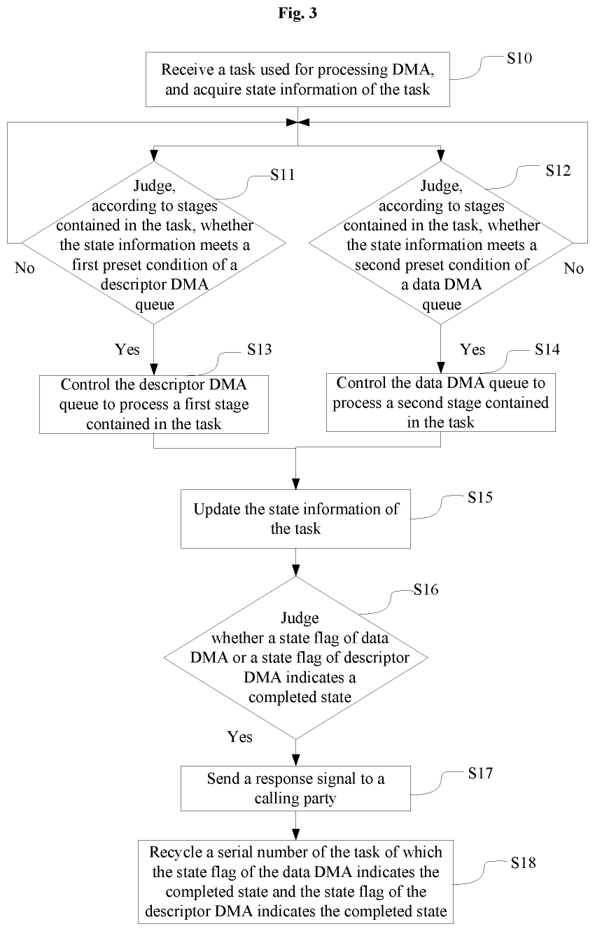

In practical implementations, when the state flag of the data DMA or the state flag of the descriptor DMA is set to be in the completed state, a conclusion of whether the current task is completely ended cannot be obtained, but a conclusion that the task of a certain stage has been completed can only be obtained. Therefore, in order to avoid this situation, on the basis of the above operations, two operations are additionally added. FIG. 3 is a flowchart of another method for processing DMA provided in the embodiments of the present disclosure. As shown in FIG. 3, in addition to operation S15, the method further includes operations S16 to S18.

At S16, whether the state flag of the data DMA or the state flag of the descriptor DMA indicates the completed state is judged, and when the state flag of the data DMA or the state flag of the descriptor DMA indicates the completed state, the flow enters operation S17.

At S17, a response signal is sent to a calling party.

At S18, the serial number of the task of which the state flag of the data DMA indicates the completed state and the state flag of the descriptor DMA indicates the completed state is recycled.

It should be noted that, judging the state flag of the data DMA or the state flag of the descriptor DMA mentioned in operation S16 refers to judging whether the other stage is also in the completed state after the processing of any stage is completed. For example, if the task A is divided into stage a and stage b, after the stage a is completed, it is judged whether the stage b is also completed, similarly, after the stage b is completed, it is judged whether the stage a is also completed. If both the stage a and the stage b are completed, a response signal is sent to the calling party, and finally, the serial number of the task of which the state flag of the data DMA indicates the completed state and the state flag of the descriptor DMA indicates the completed state is recycled, so as to recycle the serial number.

Thus it may be seen that, in the method, it is judged whether the two stages of the task are both in the completed state, when the two stages of the task are both in the completed state, the response signal is sent to the calling party, and the serial number of the task of which the state flag of the data DMA indicates the completed state and the state flag of the descriptor DMA indicates the completed state is recycled, so as to recycle the serial number. Thus it may be seen that, in the method, if the two stages are in the completed state, the response signal is sent to the calling party, thereby improving the interactivity with the calling party, the serial number is recycled to improve the cyclic utilization of the serial number, and the efficiency of the device may be improved.

In the above embodiments, the method for processing DMA is described in detail. Embodiments corresponding to an apparatus for processing DMA are provided as follows. It should be noted that, the present disclosure describes the embodiments of the apparatus portion from two aspects, one aspect is based on functional modules, and the other aspect is based on hardware.

Since the embodiments of the apparatus portion corresponds to the embodiments of the method portion, for the embodiments of the apparatus portion, reference may be made to the description of the embodiments of the method portion, and thus details are not described herein again.

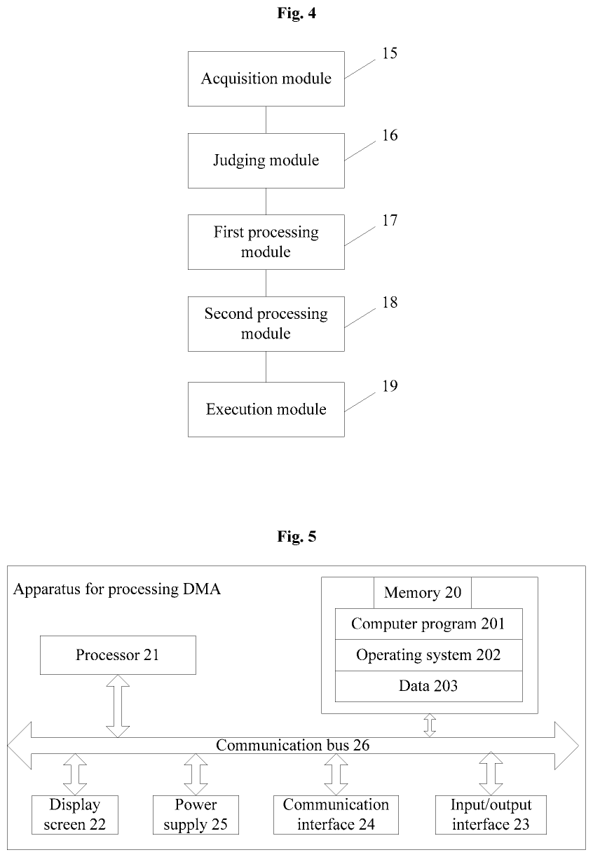

Various embodiments corresponding to the method for processing DMA are described in detail above. On this basis, an apparatus for processing DMA corresponding to the above method is provided. FIG. 4 is a structural diagram of an apparatus for processing DMA provided in the embodiments of the present disclosure. As shown in FIG. 4, the apparatus for processing DMA includes:
an acquisition module 15, configured to receive a task used for processing DMA, and acquire state information of the task;
a judging module 16, configured to judge, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task, when the state information meets the first preset condition, trigger a first processing module 17, when the state information meets the second preset condition, trigger a second processing module 18, and when the state information does not meet the first preset condition or the second preset condition, trigger an execution module 19;
the first processing module 17, configured to control the descriptor DMA queue to process the first stage contained in the task;
the second processing module 18, configured to control the data DMA queue to process the second stage contained in the task; and
the execution module 19, configured to take, as a new task, the task of the stage corresponding to the state information that does not meet the first preset condition or the second preset condition, and continue to trigger the above modules for processing.

FIG. 5 is a structural diagram of an apparatus for processing DMA provided in the embodiments of the present disclosure. As shown in FIG. 5, the apparatus for processing DMA includes:
a memory 20, used for storing a computer program; and
a processor 21, used for implementing the operations of the method for processing DMA mentioned in the above embodiments when executing the computer program.

The apparatus for processing DMA provided in the embodiments of the present disclosure may include, but is not limited to, a smart phone, a tablet computer, a notebook computer, or a desktop computer, etc.

The processor 21 may include one or more processing cores, such as a 4-core processor, an 8-core processor, or the like. The processor 21 may be implemented in at least one hardware form of a Digital Signal Processing (DSP), a Field-Programmable Gate Array (FPGA), and a Programmable Gate Array (PLA). The processor 21 may also include a main processor and a co-processor, wherein the main processor is a processor used for processing data in a wake-up state, which is also referred to as a Central Processing Unit (CPU); and the co-processor is a low-power-consumption processor used for processing data in a standby state. In some embodiments, the processor 21 may be integrated with a Graphics Processing Unit (GPU), wherein the GPU is responsible for rendering and drawing content that needs to be displayed by a display screen. In some embodiments, the processor 21 may further include an Artificial Intelligence (AI) processor, wherein the AI processor is used for processing computing operations related to machine learning.

The memory 20 may include one or more computer-readable storage media, and the computer-readable storage medium may be non-transitory. The memory 20 may further include a high-speed random access memory, and a non-volatile memory, such as one or more magnetic disk storage devices and a flash memory storage device. In the present embodiment, the memory 20 is at least used for storing the following computer program 201, wherein after being loaded and executed by a processor 21, the computer program may implement related operations of the method for processing DMA disclosed in any one of the foregoing embodiments. In addition, resources stored in the memory 20 may further include an operating system 202, data 203, and the like, and the storage mode may be temporary storage or permanent storage. The operating system 202 may include Windows, Unix, Linux, etc. The data 203 may include, but is not limited to, data of the method for processing DMA, etc.

In some embodiments, the apparatus for processing DMA may further include a display screen 22, an input/output interface 23, a communication interface 24, a power source 25 and a communication bus 26.

It may be understood by those having ordinary skill in the art that, the structure shown in FIG. 5 does not constitute a limitation on the apparatus for processing DMA, and may include more or fewer components than those illustrated.

Finally, the embodiments of the present disclosure further provide a computer-readable storage medium. A computer program is stored on the computer-readable storage medium, and when executed by a processor, the computer program causes the processor to implement the operations recorded in the above method embodiment.

It may be understood that, if the method in the foregoing embodiment is implemented in the form of a software functional unit and is sold or used as an independent product, it may be stored in a computer-readable storage medium. Based on this understanding, the technical solutions of the present disclosure substantially, or the part contributing to the prior art, or part of or all the technical solutions may be implemented in the form of a software product, the computer software product is stored in a storage medium to execute all or part of the operations of the method in various embodiments of the present disclosure. The foregoing storage medium includes a variety of media capable of storing program codes, such as a USB disk, a mobile hard disk, a Read-Only Memory (ROM), a Random Access Memory (RAM), a magnetic disk, or an optical disk, etc.

The method for processing DMA provided in the present disclosure is described in detail above. Various embodiments in the specification are described in a progressive manner, what is highlighted in each embodiment is difference with other embodiments, and the identical or similar portions between the embodiments refer to each other. With regard to the apparatus disclosed in the embodiments, it corresponds to the method disclosed in the embodiments, thus is described simply, and related portions refer to the description of the method. It should be noted that, for those having ordinary skill in the art, several improvements and modifications may also be made to the present disclosure without departing from the principle of the present disclosure, and these improvements and modifications also fall within the protection scope of the claims of the present disclosure.

It should also be noted that, in the present specification, relational terms such as first and second are merely used to distinguish one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or further includes elements inherent to such a process, method, article or device. If there are no more restrictions, the element defined by the sentence “including a . . . ” does not exclude the existence of other identical elements in the process, the method, the article or the device that includes the element.

1. A method for processing Direct Memory Access (DMA), comprising:
receiving a task used for processing DMA, and acquiring state information of the task;
judging, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task;
when the state information meets the first preset condition, controlling the descriptor DMA queue to process the first stage contained in the task; and when the state information meets the second preset condition, controlling the data DMA queue to process the second stage contained in the task; and
after the processing of the first stage or the second stage is completed, updating the state information of the task; and the flow returns to the operation of receiving the task used for processing DMA and acquiring the state information of the task by taking, as a new task, the task of the stage corresponding to the state information that does not meet the first preset condition or the second preset condition;
wherein the first preset condition is that a descriptor cache contains a next-page address entry, the priority of the task is the highest in the descriptor DMA queue, and a bandwidth quota and a flow control quota are not equal to 0; and
the second preset condition is that data DMA contains descriptor information, the priority of the task is the highest in the data DMA queue, and the bandwidth quota and the flow control quota are not equal to 0.

2. The method for processing DMA according to claim 1, wherein acquiring the state information of the task comprises:
setting a serial number corresponding to the task;
respectively writing the serial number into the data DMA queue and the descriptor DMA queue; and
acquiring the state information according to the serial number.

3. The method for processing DMA according to claim 2, wherein the state information contains Quality of Service (QOS) information, a state flag, data information and the descriptor information; and
the QoS information comprises the priority of the task and the bandwidth quota, the state flag comprises the data DMA and descriptor DMA, the data information comprises a current-page address, a current-page offset, the flow control quota and a total remaining size, and the descriptor information comprises the current-page address, the current-page offset, a descriptor cache and the number of remaining entries.

4. The method for processing DMA according to claim 3, wherein controlling the descriptor DMA queue to process the first stage contained in the task comprises:
judging whether the bandwidth quota and the flow control quota are equal to 0;
when the bandwidth quota and the flow control quota are equal to 0, executing the operation of judging, according to the stages contained in the task, whether the state information meets the first preset condition of the descriptor DMA queue and/or the second preset condition of the data DMA queue by taking the task of the first stage as a new task;
when either or both of the bandwidth quota and the flow control quota are not equal to 0, calculating a DMA parameter, wherein the DMA parameter comprises a DMA transmission size, a current-page residual and a start address;
sending a DMA read request to a Peripheral Component Interconnect Express (PCIe), and judging whether the total remaining size is equal to 0;
when the total remaining size is equal to 0, setting the descriptor DMA to be in a completed state; and
when the total remaining size is not equal to 0, returning to the operation of judging whether the bandwidth quota and the flow control quota are equal to 0;
controlling the data DMA queue to process the second stage contained in the task comprises:
judging whether the bandwidth quota and the flow control quota are equal to 0;
when the bandwidth quota and the flow control quota are equal to 0, executing the operation of judging, according to the stages contained in the task, whether the state information meets the first preset condition of the descriptor DMA queue and/or the second preset condition of the data DMA queue by taking the task of the second stage as a new task;
when either or both of the bandwidth quota and the flow control quota are not equal to 0, calculating a DMA parameter, wherein the DMA parameter comprises a DMA transmission size, a current-page residual and a start address;
sending a DMA read request to the PCIe, and judging whether the total remaining size is equal to 0;
when the total remaining size is equal to 0, setting the data DMA to be in a completed state; and
when the total remaining size is not equal to 0, returning to the operation of judging whether the bandwidth quota and the flow control quota are equal to 0.

5. The method for processing DMA according to claim 4, wherein after setting the descriptor DMA to be in the completed state, the method further comprises: judging whether the state flag of the data DMA indicates the completed state; and when the state flag of the data DMA indicates the completed state, sending a response signal to a calling party; or,
after setting the data DMA to be in the completed state, the method further comprises: judging whether the state flag of the descriptor DMA indicates the completed state; and when the state flag of the descriptor DMA indicates the completed state, sending a response signal to a calling party.

6. The method for processing DMA according to claim 5, wherein after sending the response signal to the calling party via a bus, the method further comprises: recycling the serial number of the task of which the state flag of the data DMA indicates the completed state and the state flag of the descriptor DMA indicates the completed state.

7. (canceled)

8. An apparatus for processing DMA, comprising a memory, used for storing a computer program; and
a processor, used for implementing following operations when executing the computer program;
receiving a task used for processing DMA, and acquiring state information of the task;
judging, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task;
when the state information meets the first preset condition, controlling the descriptor DMA queue to process the first stage contained in the task; and when the state information meets the second preset condition, controlling the data DMA queue to process the second stage contained in the task; and
after the processing of the first stage or the second stage is completed, updating the state information of the task; and the flow returns to the operation of receiving the task used for processing DMA and acquiring the state information of the task by taking, as a new task, the task of the stage corresponding to the state information that does not meet the first preset condition or the second preset condition;
wherein the first preset condition is that a descriptor cache contains a next-page address entry, the priority of the task is the highest in the descriptor DMA queue, and a bandwidth quota and a flow control quota are not equal to 0; and
the second preset condition is that data DMA contains descriptor information, the priority of the task is the highest in the data DMA queue, and the bandwidth quota and the flow control quota are not equal to 0.

9. A computer-readable storage medium, wherein a computer program is stored on the computer-readable storage medium, and when executed by a processor, the computer program causes the processor to implement following operations;
receiving a task used for processing DMA, and acquiring state information of the task;
judging, according to stages contained in the task, whether the state information meets a first preset condition of a descriptor DMA queue and/or a second preset condition of a data DMA queue, wherein the descriptor DMA queue is used for processing a first stage contained in the task, and the data DMA queue is used for processing a second stage contained in the task;
when the state information meets the first preset condition, controlling the descriptor DMA queue to process the first stage contained in the task; and when the state information meets the second preset condition, controlling the data DMA queue to process the second stage contained in the task; and
after the processing of the first stage or the second stage is completed, updating the state information of the task; and the flow returns to the operation of receiving the task used for processing DMA and acquiring the state information of the task by taking, as a new task, the task of the stage corresponding to the state information that does not meet the first preset condition or the second preset condition;
wherein the first preset condition is that a descriptor cache contains a next-page address entry, the priority of the task is the highest in the descriptor DMA queue, and a bandwidth quota and a flow control quota are not equal to 0; and
the second preset condition is that data DMA contains descriptor information, the priority of the task is the highest in the data DMA queue, and the bandwidth quota and the flow control quota are not equal to 0.

10. The method for processing DMA according to claim 1, wherein after receiving the task used for processing DMA, the method further comprises: storing the task in a task queue; and
acquiring the state information of the task comprises:
acquiring, by a task parser in a DMA controller, the state information of the task based on the task in the task queue, and storing, by the task parser, the state information in a task context information storage unit in the DMA controller.

11. The method for processing DMA according to claim 10, wherein the DMA controller comprises a plurality of task context information storage units that are able to be processed simultaneously, each task corresponding to one task context storage unit.

12. The method for processing DMA according to claim 1, wherein the data DMA queue comprises a first candidate queue, a data DMA filter, a first work queue and a data DMA processor; and the descriptor DMA queue comprises a second candidate queue, a descriptor DMA filter, a second work queue and a descriptor DMA processor.

13. The method for processing DMA according to claim 1, wherein judging, according to the stages contained in the task, whether the state information meets the first preset condition of the descriptor DMA queue and/or the second preset condition of the data DMA queue comprises:
when the task is currently in the first stage, judging whether the state information meets the first preset condition of the descriptor DMA queue, and judging whether the state information meets the second preset condition of the data DMA queue;
when the task is currently in the second stage, directly judging whether the state information meets the second preset condition of the data DMA queue, and performing another task in the first stage at the same time.

14. The apparatus for processing DMA according to claim 8, wherein acquiring the state information of the task comprises:
setting a serial number corresponding to the task;
respectively writing the serial number into the data DMA queue and the descriptor DMA queue; and
acquiring the state information according to the serial number.

15. The apparatus for processing DMA according to claim 14, wherein the state information contains Quality of Service (QOS) information, a state flag, data information and the descriptor information; and
the QoS information comprises the priority of the task and the bandwidth quota, the state flag comprises the data DMA and descriptor DMA, the data information comprises a current-page address, a current-page offset, the flow control quota and a total remaining size, and the descriptor information comprises the current-page address, the current-page offset, a descriptor cache and the number of remaining entries.

16. The apparatus for processing DMA according to claim 15, wherein controlling the descriptor DMA queue to process the first stage contained in the task comprises:
judging whether the bandwidth quota and the flow control quota are equal to 0;
when the bandwidth quota and the flow control quota are equal to 0, executing the operation of judging, according to the stages contained in the task, whether the state information meets the first preset condition of the descriptor DMA queue and/or the second preset condition of the data DMA queue by taking the task of the first stage as a new task;
when either or both of the bandwidth quota and the flow control quota are not equal to 0, calculating a DMA parameter, wherein the DMA parameter comprises a DMA transmission size, a current-page residual and a start address;
sending a DMA read request to a Peripheral Component Interconnect Express (PCIe), and judging whether the total remaining size is equal to 0;
when the total remaining size is equal to 0, setting the descriptor DMA to be in a completed state; and
when the total remaining size is not equal to 0, returning to the operation of judging whether the bandwidth quota and the flow control quota are equal to 0;
controlling the data DMA queue to process the second stage contained in the task comprises:
judging whether the bandwidth quota and the flow control quota are equal to 0;
when the bandwidth quota and the flow control quota are equal to 0, executing the operation of judging, according to the stages contained in the task, whether the state information meets the first preset condition of the descriptor DMA queue and/or the second preset condition of the data DMA queue by taking the task of the second stage as a new task;
when either or both of the bandwidth quota and the flow control quota are not equal to 0, calculating a DMA parameter, wherein the DMA parameter comprises a DMA transmission size, a current-page residual and a start address;
sending a DMA read request to the PCIe, and judging whether the total remaining size is equal to 0;
when the total remaining size is equal to 0, setting the data DMA to be in a completed state; and
when the total remaining size is not equal to 0, returning to the operation of judging whether the bandwidth quota and the flow control quota are equal to 0.

17. The apparatus for processing DMA according to claim 16, wherein after setting the descriptor DMA to be in the completed state, the processor is used for further implementing following operations when executing the computer program: judging whether the state flag of the data DMA indicates the completed state; and when the state flag of the data DMA indicates the completed state, sending a response signal to a calling party; or,
after setting the data DMA to be in the completed state, the processor is used for further implementing following operations when executing the computer program: judging whether the state flag of the descriptor DMA indicates the completed state; and when the state flag of the descriptor DMA indicates the completed state, sending a response signal to a calling party.

18. The apparatus for processing DMA according to claim 17, wherein after sending the response signal to the calling party, the processor is used for further implementing following operations when executing the computer program: recycling the serial number of the task of which the state flag of the data DMA indicates the completed state and the state flag of the descriptor DMA indicates the completed state.

19. The apparatus for processing DMA according to claim 8, wherein after receiving the task used for processing DMA, the processor is used for further implementing following operations when executing the computer program: storing the task in a task queue; and
acquiring the state information of the task comprises:
acquiring, by a task parser in a DMA controller, the state information of the task based on the task in the task queue, and storing, by the task parser, the state information in a task context information storage unit in the DMA controller.

20. The apparatus for processing DMA according to claim 19, wherein the DMA controller comprises a plurality of task context information storage units that are able to be processed simultaneously, each task corresponding to one task context storage unit.

21. The apparatus for processing DMA according to claim 8, wherein judging, according to the stages contained in the task, whether the state information meets the first preset condition of the descriptor DMA queue and/or the second preset condition of the data DMA queue comprises:
when the task is currently in the first stage, judging whether the state information meets the first preset condition of the descriptor DMA queue, and judging whether the state information meets the second preset condition of the data DMA queue;
when the task is currently in the second stage, directly judging whether the state information meets the second preset condition of the data DMA queue, and performing another task in the first stage at the same time.
